(19) United States
(12) Patent Application Publication
(10) Pub. No.: US 2025/0337957 A1
(43) Pub. Date: Oct. 30, 2025

(54) GRADIENT AND LOCATION BASED FILTERED INTRA BLOCK COPY

(71) Applicant: Tencent America LLC, Palo Alto, CA (US)

(72) Inventors: Biao WANG, San Jose, CA (US); Lien-Fei CHEN, Palo Alto, CA (US); Roman CHERNYAK, Santa Clara, CA (US); Xin ZHAO, San Jose, CA (US)

(73) Assignee: Tencent America LLC, Palo Alto, CA (US)

(21) Appl. No.: 19/258,791

(22) Filed: Jul. 2, 2025

Related U.S. Application Data
(63) Continuation of application No. PCT/US2024/025854, filed on Apr. 23, 2024.
(60) Provisional application No. 63/462,235, filed on Apr. 26, 2023.

(51) Int. Cl. H04N 19/80; H04N 19/176; H04N 19/593; H04N 19/70

(52) U.S. Cl. CPC H04N 19/80; H04N 19/176; H04N 19/593; H04N 19/70

(57) ABSTRACT

Aspects of the disclosure includes methods and apparatuses for video decoding and video encoding and a method of processing visual media data. The apparatus for video decoding includes processing circuitry configured to: receive coded information indicating that a current block in a current picture is predicted using a filtered intra block copy (FIBC) mode; determine a linear predicted value of a current sample in the current block by applying a linear filter to prediction samples predicted using one of an IBC mode and an intra template matching (IntraTMP) mode; determine a gradient value associated with the current sample using at least one gradient filter; determine a predicted value of the current sample based on a sum of the linear predicted value and at least one modification value that includes the gradient value. An FIBC filter in the FIBC mode includes the linear filter and the at least one gradient filter.

### RELATED APPLICATION

The present application is a continuation of International Application No. PCT/US2024/025854, filed on Apr. 23, 2024, which claims the benefit of priority to U.S. Provisional Application No. 63/462,235, “Gradient and Location based Filtered Intra Block Copy” filed on Apr. 26, 2023. The entire disclosures of the prior applications are hereby incorporated herein by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include methods and apparatuses for video encoding/decoding.

In an aspect, a method of processing visual media data includes processing a bitstream of the visual media data according to a format rule. The bitstream includes a syntax element indicating that a current block in a current picture is predicted using a filtered intra block copy (FIBC) mode. The format rule specifies that a linear predicted value of a current sample in the current block is determined by applying a linear filter to samples that are predicted using one of an intra block copy (IBC) mode and an intra template matching (IntraTMP) mode. The format rule specifies that a gradient value associated with the current sample in the current block is determined using at least one gradient filter. The format rule specifies that a nonlinear value associated with the current sample is determined from at least one of the current sample and neighboring samples of the current sample using a nonlinear relationship between the nonlinear value and values of the at least one of the current sample and the neighboring samples. The format rule specifies that a location value is based on a location of a center sample that is at a center of the linear filter. The format rule specifies that a predicted value of the current sample is based on a sum of the linear predicted value and at least one modification value that includes the gradient value, the nonlinear value, and the location value, an FIBC filter in the FIBC mode including the linear filter, the at least one gradient filter, a coefficient for the nonlinear value, and coefficients for the location. The format rule specifies that the current sample is processed from the predicted value of the current sample.

In an example, the linear filter includes a bias term.

In an example, the linear filter is configured to add a mean value of the current block and removes the mean value of the current block from each of the samples that are predicted using the one of the IBC mode and the IntraTMP mode.

In an aspect, a method for video encoding includes determining a linear predicted value of a current sample in a current block by applying a linear filter to samples that are predicted using one of an intra block copy (IBC) mode and an intra template matching (IntraTMP) mode, the current block being predicted using a filtered IBC (FIBC) mode; determining a gradient value associated with the current sample in the current block using at least one gradient filter; determining a nonlinear value associated with the current sample from at least one of the current sample and neighboring samples of the current sample using a nonlinear relationship between the nonlinear value and values of the at least one of the current sample and the neighboring samples; determining a predicted value of the current sample based on a sum of the linear predicted value and at least one modification value that includes the gradient value and the nonlinear value, an FIBC filter in the FIBC mode including the linear filter, the at least one gradient filter, and a coefficient for the nonlinear value; and encoding the current sample from the predicted value of the current sample.

In an example, the method for video encoding further includes determining a location value using a location of a center sample that is at a center of the linear filter; and determining the predicted value of the current sample based on the sum of the linear predicted value and the at least one modification value that includes the gradient value, the nonlinear value, and the location value, the FIBC filter in the FIBC mode including the linear filter, the at least one gradient filter, the coefficient for the nonlinear value, and coefficients for the location.

In an example, the linear filter includes a bias term; or the linear filter is configured to add a mean value of the current block and remove the mean value of the current block from each of the samples that are predicted using the one of the IBC mode and the IntraTMP mode.

According to an aspect of the disclosure, an apparatus for video decoding includes processing circuitry. The processing circuitry is configured to: receive coded information indicating that a current block in a current picture is predicted using a filtered intra block copy (FIBC) mode; determine a linear predicted value of a current sample in the current block by applying a linear filter to prediction samples that are predicted using one of an IBC mode and an intra template matching (IntraTMP) mode; determine a gradient value associated with the current sample in the current block using at least one gradient filter; determine a predicted value of the current sample based on a sum of the linear predicted value and at least one modification value that includes the gradient value, an FIBC filter in the FIBC mode including the linear filter and the at least one gradient filter; and reconstruct the current sample from the predicted value of the current sample.

In an example, the processing circuitry is configured to: determine a location value using a location of a center sample that is at a center of the linear filter; and determine the predicted value of the current sample based on a sum of the linear predicted value and the at least one modification value that includes the gradient value and the location value, the FIBC filter in the FIBC mode including the linear filter, the at least one gradient filter, and coefficients for the location.

In an example, the processing circuitry is configured to: determine a nonlinear value associated with the current sample from at least one of the current sample and neighboring samples of the current sample using a nonlinear relationship between the nonlinear value and values of the at least one of the current sample and the neighboring samples; and determine the predicted value of the current sample based on a sum of the linear predicted value and the at least one modification value that includes the gradient value and the nonlinear value, the FIBC filter in the FIBC mode including the linear filter, the at least one gradient filter, and a coefficient for the nonlinear value.

In an example, the linear filter includes a bias term.

In an example, the linear filter adds a mean value of the current block and removes the mean value of the current block from each of the samples that are predicted using the one of the IBC mode and the IntraTMP mode.

In an example, the processing circuitry is configured to clip the predicted value of the current sample.

In an example, the processing circuitry is configured to determine coefficients of the FIBC filter in the FIBC mode from a current template of the current block and a reference template of a reference block indicated by a block vector of the current block.

In an example, the processing circuitry is configured to determine the coefficients of the FIBC filter in the FIBC mode using LDL decomposition.

In an example, the linear filter has a cross-shape that includes: (i) 5 samples that include a center sample of the linear filter with an offset of (0, 0), a North sample N with an offset of (0, −1), a South sample S with an offset of (0, 1), an East sample E with an offset of (1, 0), and a West sample W with an offset of (−1, 0), the offsets of the 5 samples in the linear filter are with respect to the center sample; or (ii) 9 samples that include a center sample of the linear filter with an offset of (0, 0), two North samples with respective offsets of (0, −1) and (0, −2), two South samples with respective offsets of (0, 1) and (0, 2), two East samples with respective offsets of (1, 0) and (2, 0), and two West samples with respective offsets of (−1, 0) and (−2, 0), the offsets of the 9 samples in the linear filter are with respect to the center sample.

In an example, when the linear filter has the 5 samples, the current sample is located at one of 5 positions of the respective 5 samples; and when the linear filter has the 9 samples, the current sample is located at one of 9 positions of the respective 9 samples.

In an example, a shape of the linear filter is predefined, and one or more shapes of the at least one gradient filter are predefined.

In an example, a sample in the linear filter is spatially separated from all remaining samples in the linear filter.

In an example, when the at least one gradient filter consists of a horizontal gradient filter, the gradient value is a horizontal gradient value, and a number of first input samples and positions of the first input samples in the horizontal gradient filter are set independently from the linear filter; when the at least one gradient filter consists of a vertical gradient filter, the gradient value is a vertical gradient value, and a number of second input samples and positions of the second input samples in the vertical gradient filter are set independently from the linear filter; and when the at least one gradient filter includes a horizontal gradient filter and a vertical gradient filter, the gradient value is a sum of a horizontal gradient value and a vertical gradient value, and the number of the first input samples and the positions of the first input samples in the horizontal gradient filter and the number of the second input samples and the positions of the second input samples in the vertical gradient filter are set independently from each other and from the linear filter.

In an example, the at least one gradient filter includes a horizontal gradient filter; the gradient value includes a horizontal gradient value that is a sum of horizontal gradients of respective first input samples in the horizontal gradient filter; and the processing circuitry is configured to determine each horizontal gradient of the respective first input samples based on one of: (i) a difference between the respective first input sample and a left neighbor of the respective first input sample; (ii) a difference between the left neighbor of the first input sample and a right neighbor of the respective first input sample; and (iii) a difference between a first value and a second value, the first value being a sum based on a top-left neighbor, the left neighbor, and a bottom-left neighbor of the first input sample, the second value being a sum based on a top-right neighbor, the right neighbor, and a bottom-right neighbor of the first input sample.

In an example, the processing circuitry is configured to determine which of the differences is used to calculate the horizontal gradient of the respective first input sample based on a position of the respective first input sample.

In an example, the at least one gradient filter includes a vertical gradient filter; the gradient value includes a vertical gradient value that is a sum of vertical gradients of respective second input sample in the vertical gradient filter. The processing circuitry is configured to determine each vertical gradient of the respective second input sample based on one of: (i) a difference between the respective second input sample and a top neighbor of the respective second input sample; (ii) a difference between the top neighbor of the respective second input sample and a bottom neighbor of the respective second input sample; and (iii) a difference between a first value and a second value, the first value being a sum based on a top-left neighbor, the top neighbor, and a top-right neighbor of the second input sample, the second value being a sum based on bottom-left neighbor, the bottom neighbor, and a bottom-right neighbor of the respective second input sample.

In an example, the processing circuitry is configured to determine which of the differences is used to calculate the vertical gradient of the respective second input sample based on a position of the respective second input sample.

Aspects of the disclosure also provide an apparatus for video encoding. The apparatus for video encoding including processing circuitry configured to implement any of the described methods for video encoding.

Aspects of the disclosure also provide a method for video decoding. The method including any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows an example of a convolutional filter according to an aspect of the disclosure.

FIG. 5 shows an example of a reference area used to derive filter coefficients according to an aspect of the disclosure.

FIG. 6 shows examples of spatial samples used for a gradient and location based convolutional cross-component model (GL-CCCM) according to an aspect of the disclosure.

FIG. 7A shows an example of an intra template matching prediction (IntraTMP) mode according to an aspect of the disclosure.

FIG. 7B shows an example of modification of a filtered intra block copy (FIBC) model according to an aspect of the disclosure.

FIGS. 8-10 show examples of available filters in the FIBC mode according to aspects of the disclosure.

FIG. 11 shows an example of neighboring samples of an input sample C used for calculating gradients according to an aspect of the disclosure.

FIG. 12 shows an example of choosing a gradient calculation method according to an aspect of the disclosure.

FIG. 13 shows an example of locations of samples C, A, L, and AL, respectively according to an aspect of the disclosure.

FIG. 14 shows a flow chart outlining a decoding process according to some aspects of the disclosure.

FIG. 15 shows a flow chart outlining an encoding process according to some aspects of the disclosure.

FIG. 16 is a schematic illustration of a computer system in accordance with an aspect.

### DETAILED DESCRIPTION

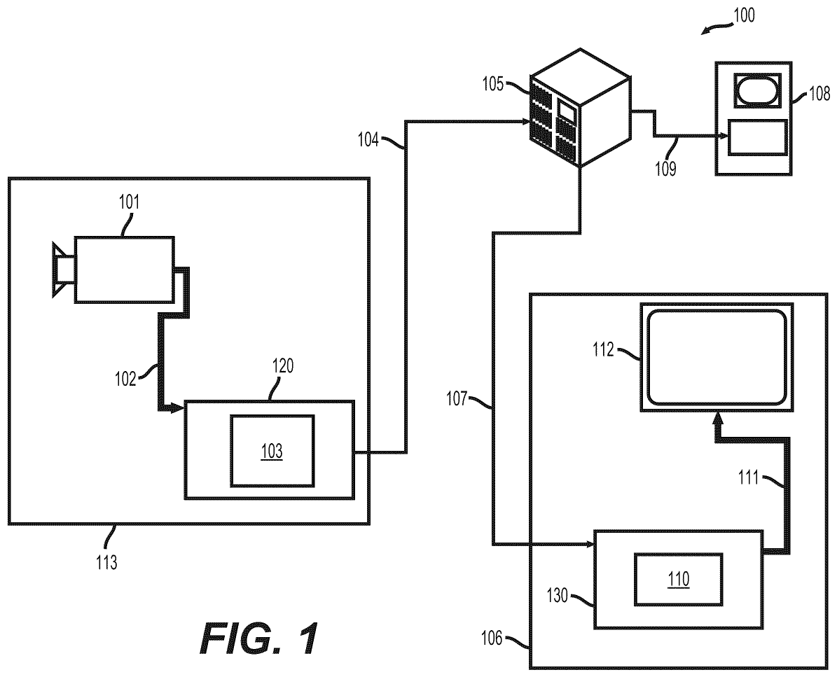

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

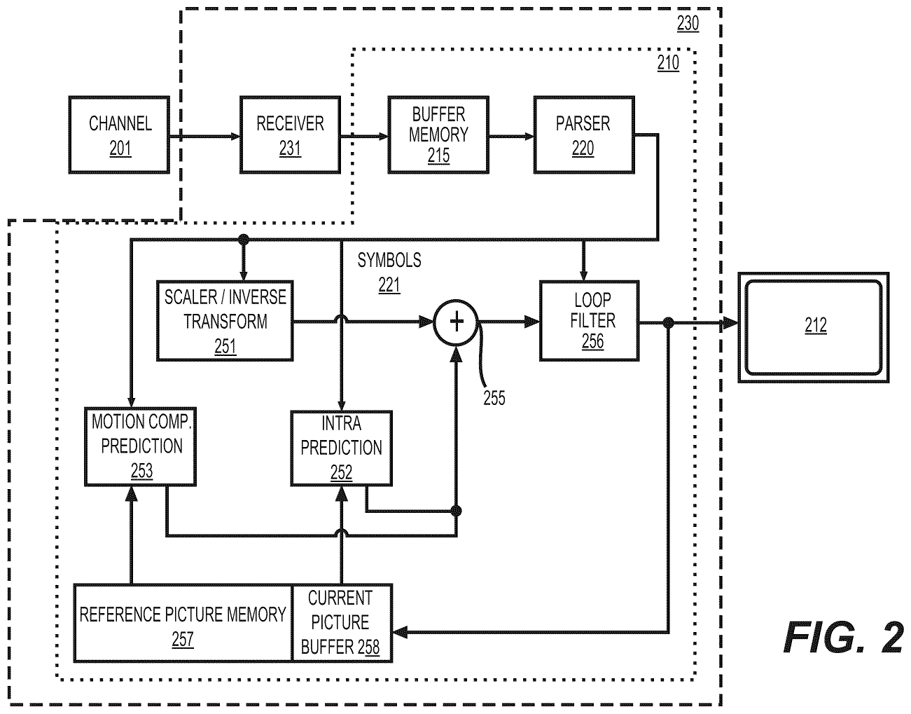

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

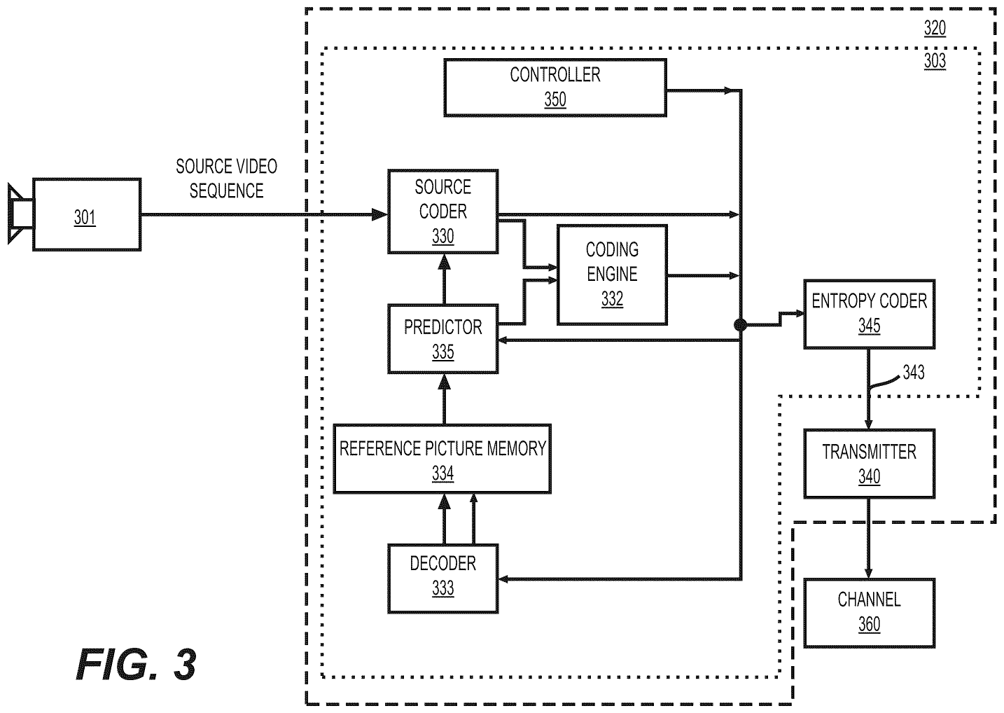

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Convolutional cross-component intra prediction model may be used such as in ECM. A convolutional cross-component model (CCCM) may be applied to predict chroma samples from reconstructed luma samples in a similarly as done by the current CCLM modes. As with CCLM, the reconstructed luma samples may be down-sampled to match the lower resolution chroma grid when chroma sub-sampling is used. Similar to CCLM, top, left, or top and left reference samples may be used as templates for model derivation.

Similarly to CCLM, there may be an option of using a single model or multi-model variant of CCCM. The multi-model variant may use two models, one model derived for samples above the average luma reference value and another model for the rest of the samples (following the spirit of the CCLM design). Multi-model CCCM mode can be selected for PUs which, for example, have at least 128 reference samples available.

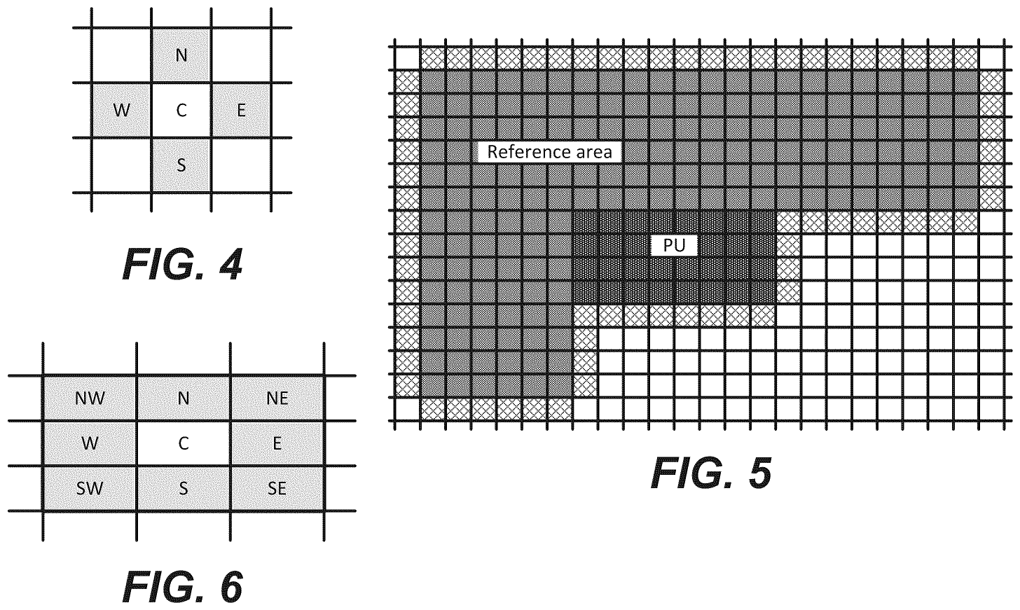

A convolutional filter, such as a convolutional 7-tap filter may include (e.g., consist of) a 5-tap plus sign shape spatial component, a nonlinear term, and a bias term. The input to the spatial 5-tap component of the filter may include (e.g., consist of) a center (C) luma sample which is collocated with the chroma sample to be predicted and its above or north (N), below or south (S), left or west (W) and right or east (E) neighbors as illustrated in FIG. 4.

The nonlinear term NP may be represented as power of two of the center luma sample C and may be scaled to the sample value range of the content such as described in Eq. 1.

$$NP = ( {C}^{2} + midVal ) ≫ bitDepth \qquad Eq . 1$$

That is, for 10-bit content the nonlinear term NP may be calculated using Eq. 2.

$$NP = ( {C}^{2} + 512 ) ≫ 10 \qquad Eq . 2$$

The middle value (midVal) is 2¹⁰/2, which is 512.

The bias term B may represent a scalar offset between the input and output (e.g., similar to the offset term in CCLM) and may be set to a middle chroma value (e.g., 512 for 10-bit content).

An output of the filter may be calculated as a convolution between the filter coefficients cᵢ and the input values and may be clipped to the range of valid chroma samples using Eq. 3.

$$predChromaVal = {c}_{0} C + {c}_{1} N + {c}_{2} S + {c}_{3} E + {c}_{4} W + {c}_{5} P + {c}_{6} B \qquad Eq . 3$$

The filter coefficients cᵢ may be calculated, for example, by minimizing a mean squared error (MSE) between predicted and reconstructed chroma samples in the reference area. FIG. 5 shows an example of the reference area (with its paddings) used to derive the filter coefficients according to an aspect of the disclosure. The reference area may include (e.g., consist of) 6 lines of chroma samples above and to the left of the PU. The reference area may extend one PU width to the right and one PU height below the PU boundaries. The area may be adjusted to include only available samples. The extensions to the area may be used to support the “side samples” of the plus shaped spatial filter and are padded when in unavailable areas.

The MSE minimization may be performed by a calculating autocorrelation matrix for the luma input and a cross-correlation vector between the luma input and chroma output. Autocorrelation matrix may be LDL decomposed and the final filter coefficients may be calculated using back-substitution. The process follows roughly the calculation of the ALF filter coefficients such as used in ECM, however LDL decomposition was chosen instead of Cholesky decomposition, for example, to avoid using square root operations.

The autocorrelation matrix may be calculated using the reconstructed values of luma and chroma samples. The luma and chroma samples may be in a full range (e.g., between 0 and 1023 for 10-bit content) resulting in relatively large values in the autocorrelation matrix. This may use high bit depth operation during the model parameters calculation. Fixed offsets may be removed from luma and chroma samples in each PU for each model. This may reduce the magnitudes of the values used in the model creation and allow reducing the precision for the fixed-point arithmetic. As a result, in some examples, 16-bit decimal precision may be used instead of the 22-bit precision of the original CCCM implementation.

In some examples, reference sample values just outside of the top-left corner of the PU may be used as the offsets (offsetLuma, offsetCb and offsetCr) for simplicity. The samples values used in both model creation and final prediction (e.g., luma and chroma in the reference area, and luma in the current PU) may be reduced by the fixed values, as follows: C′=C−offsetLuma; N′=N−offsetLuma; S′=S−offsetLuma; E′=E−offsetLuma; W′=W−offsetLuma; P′=nonLinear(C′); B=midValue=1<<(bitDepth−1); and the chroma value be predicted using Eq. 4, where offsetChroma is equal to offsetCr and offsetCb for Cr and Cb components, respectively.

predChromaVal=c₀C′+c₁N′+c₂S′+c₃E′+c₄W′+c₅P′+c₆B+offsetChroma Eq. 4

In an example, to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation, the chroma offset may be added to the bias term of the convolutional model.

The process of CCCM model parameter calculation may use division operations. In some examples, division operations may not be implementation friendly. The division operation may be replaced with multiplication (with a scale factor) and shift operation, where a scale factor and a number of shifts may be calculated based on a denominator, for example, similar to the method used in calculation of CCLM parameters.

A gradient and location based convolutional cross-component model (GL-CCCM) may map luma values into chroma values using a filter with inputs including (e.g., consisting of) one spatial luma sample, two gradient values, two location information, a nonlinear term, and a bias term. The GL-CCCM method may use gradient and location information instead of the 4 spatial neighbor samples used in the CCCM filter. The GL-CCCM filter used for the prediction may be described using Eq. 5.

$$predChromaVal = {c}_{0} C + {c}_{1} {G}_{y} + {c}_{2} {G}_{x} + {c}_{3} Y + {c}_{4} X + {c}_{5} P + {c}_{6} B \qquad Eq . 5$$

FIG. 6 shows examples of spatial samples used for the GL-CCCM according to an aspect of the disclosure. Gy and Gx are the vertical and horizontal gradients, respectively, and are calculated using Eq. 6.

$${G}_{y} = ( 2 N + N W + N E ) - ( 2 S + S W + S E ) \qquad Eq . 6$$

$${G}_{x} = ( 2 W + N W + S W ) - ( 2 E + NE + SE )$$

The Y and X are the spatial coordinates of the center luma sample.

The rest of the parameters may be the same as CCCM tool. The reference area for the parameter calculation may be the same as CCCM method.

The usage of the GL-CCCM mode may be signaled with a flag, such as a CABAC coded PU level flag. The GL-CCCM mode may be considered a sub-mode of CCCM in terms of signaling, for example, the GL-CCCM flag is only signaled if the original CCCM flag is true.

Similar to the CCCM, in some examples, the GL-CCCM tool has 6 modes for calculating the parameters: a single-model GL-CCCM from above and left templates; a single-model GL-CCCM from the above template; a single-model GL-CCCM from the left template; a multi-model GL-CCCM from the above and left templates; a multi-model GL-CCCM from the above template; and a multi-model GL-CCCM from the left template. The encoder may perform a search (e.g., a sum of absolute transformed differences (SATD) search) for the 6 GL-CCCM modes along with the existing CCCM modes to find the best candidates for full rate-distortion (RD) tests.

An intra block copy (IBC) mode and an intra template matching prediction (intraTMP) mode may be used to predict a block in a current picture, for example, from a reference block (e.g., a reconstructed block) in the current picture.

In an aspect, the IBC mode is a tool adopted in HEVC extensions on screen content coding (SCC). In some examples, the IBC mode may significantly improve the coding efficiency of screen content materials. Since the IBC mode may be implemented as a block level coding mode, block matching (BM) may be performed at the encoder to find the optimal block vector (BV) for each CU. In the IBC mode, a BV may be used to indicate a displacement from the current block to a reference block, which is already reconstructed inside the current picture. In an example, the BV may be considered as a motion vector with the reference picture being the current picture. The luma BV of an IBC-coded CU may be in an integer precision. The chroma BV may round to an integer precision. When combined with an adaptive motion vector resolution (AMVR) mode, the IBC mode can switch between 1-pel and 4-pel precisions (e.g., also referred to as 1-pel and 4-pel motion vector precisions). The IBC mode that may code an IBC-coded CU may be treated as the third prediction mode in addition to an intra prediction mode and an inter prediction mode. The IBC mode may be applicable to the CUs with both width and height smaller than or equal to 64 luma samples.

At the encoder side, hash-based motion estimation may be performed for the IBC mode. The encoder may perform rate-distortion (RD) check for blocks with either width or height no larger than 16 luma samples. For a non-merge mode, the block vector search may be performed using hash-based search first. If hash search does not return a valid candidate, block matching based local search may be performed.

In the hash-based search, hash key matching (32-bit CRC) between the current block and a reference block may be extended to all allowed block sizes. The hash key calculation for every position in the current picture may be based on 4×4 subblocks. For the current block of a larger size, a hash key may be determined to match that of the reference block when all the hash keys of all 4×4 subblocks match the hash keys in the corresponding reference locations. If hash keys of multiple reference blocks are found to match that of the current block, the block vector costs of each matched reference may be calculated and the one with the minimum cost may be selected.

In block matching search, the search range may be set to include both the previous and current CTUs (e.g., the previously reconstructed CTU and the current CTU).

At a CU level, the IBC mode may be signaled with a flag and may be signaled as an IBC adaptive motion vector prediction (AMVP) mode or an IBC skip/merge mode as follows.

For the IBC skip/merge mode: a merge candidate index may be used to indicate which of the block vectors in a merge list from neighboring candidate IBC coded blocks is used to predict the current block. The merge list may include spatial candidate(s), HMVP candidate(s), and pairwise candidate(s). In an example, the merge list consists of spatial candidate(s), HMVP candidate(s), and pairwise candidate(s).

For the IBC AMVP mode: a block vector difference (BVD) may be coded in the same way as a motion vector difference. The block vector prediction method may use two candidates as predictors, one from a left neighbor (if IBC coded) and one from an above neighbor (if IBC coded). When either neighbor is not available, a default BV may be used as a predictor. A flag may be signaled to indicate a block vector predictor index.

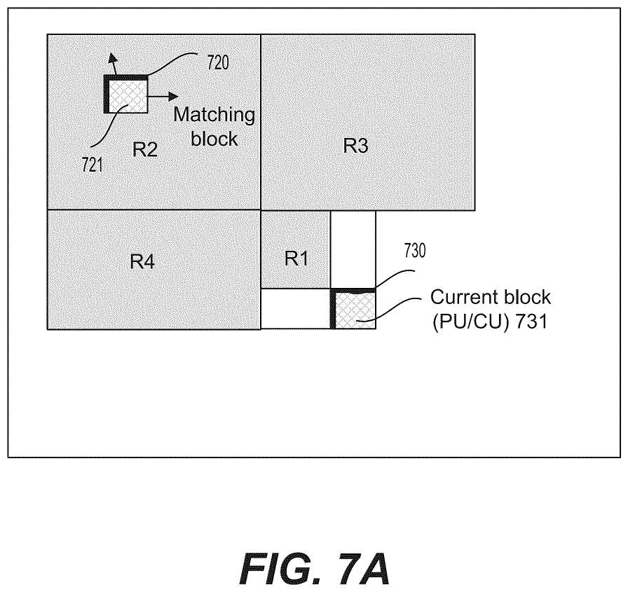

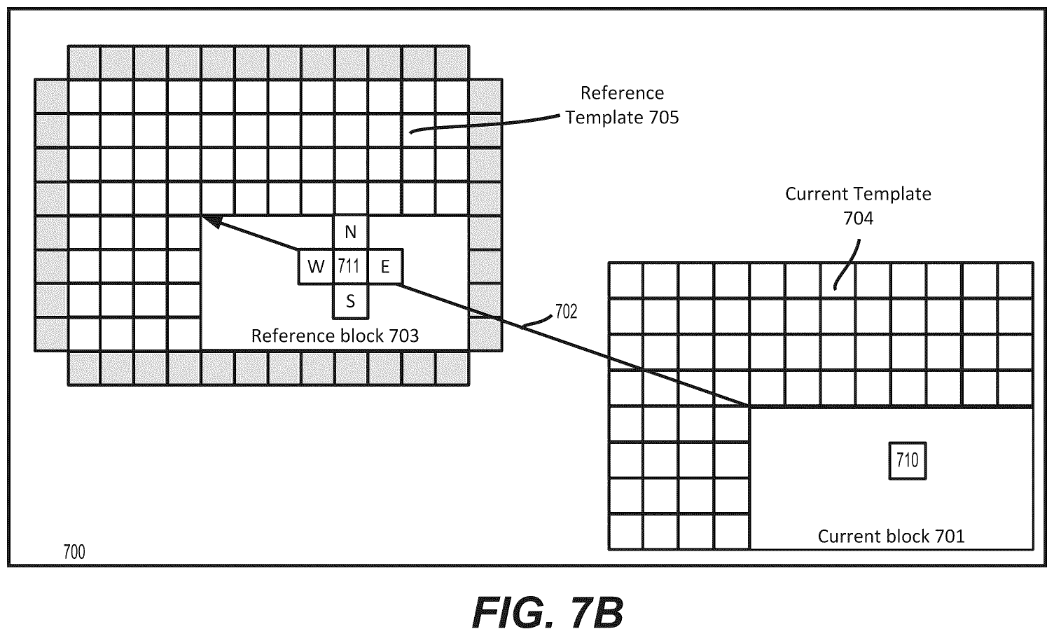

FIG. 7A shows an example of an intra template matching prediction (IntraTMP) mode according to an aspect of the disclosure. In an aspect, such as in Enhanced Compression Model (ECM) software, the IntraTMP is a special intra prediction mode that can copy the best prediction block (e.g., a matching block (721)) from a reconstructed part of a current frame (or a current picture), where a template (e.g., an L-shaped template) (720) of the best prediction block can match a current template (730) of a current block (731) (e.g., a current PU or a current CU). For a predefined search range, an encoder can search for the most similar template to the current template in the reconstructed part of the current frame and can use the corresponding block as a prediction block. The encoder can signal the usage of the IntraTMP mode, and the same prediction operation can be performed at the decoder side.

The prediction signal can be generated by matching the current template (730), such as an L-shaped causal neighbor of the current block (731), with a template of another block in a predefined search area. An example search area shown in FIG. 7A can include multiple CTUs (or superblocks). Referring to FIG. 7A, the search area can include a current CTU R1 (e.g., a portion of the current CTU R1), a top-left CTU R2, an above CTU R3, and a left CTU R4. The cost function can include any suitable cost function, such as a sum of absolute differences (SAD).

Within each region, the decoder can search for a template that has the least cost (e.g., the least SAD) with respect to the current template and can use a block associated with the template having the least cost as a prediction block.

Dimensions of regions indicated by (SearchRange_w, SearchRange_h) can be set to be proportional to a block dimension (BlkW, BlkH) to have a fixed number of SAD comparisons per pixel. Thus, SearchRange_w=a×BlkW and SearchRange_h=a×BlkH.

The parameter ‘a’ can be a constant that controls the trade-off between the gain and the complexity. In an example, ‘a’ is 5.

In an example, to speed-up the template matching process, the search range (e.g., the search range of all search regions) is subsampled by a factor of 2, which leads to a reduction of a template matching search by a factor of 4. After the best match (or an initial best match) is found, a refinement process can be performed. The refinement is done via a second template matching search around the best match (or the initial best match) with a reduced range. The reduced range is defined as min (BlkW, BlkH)/2.

The Intra template matching tool can be enabled for CUs with size less than or equal to 64 in width and height. The maximum CU size (e.g., 64) for intra template matching can be configurable.

A filtered intra block copy (FIBC) model may be used, for example, with the IBC mode or the IntraTMP mode. In an aspect, the prediction samples of the IBC mode or the IntraTMP mode may be enhanced by applying a linear filter. Referring Back to FIG. 4, in an example, the linear filter consists of five spatial terms and a bias term, as shown in Eq. 7. The five spatial terms consist of a center (C) position, an above/north neighbor (N), a below/south neighbor (S), a left/west neighbor (W), and a right/east neighbor (E).

$$predVal = {α}_{0} \cdot C + {α}_{1} \cdot N + {α}_{2} \cdot S + {α}_{3} \cdot W + {α}_{4} \cdot E + {α}_{5} \cdot β \qquad Eq . 7$$

a; is the coefficient (e.g., i being 0 to 5) and R is the offset associated with the bias term. Up to 4 lines/columns of samples above and left to the current CU may be applied to derive the filter coefficients (e.g., including α₀ to α₅). The filter coefficients may be derived based on the minimization of a difference between the template samples and the corresponding reference samples via a regression-based minimization technique such as the same regression-based minimization technique in the ECM that is used by other tools such as the CCCM described in the disclosure.

For the signaling, an extra indication flag (also referred to as an FIBC flag) may be introduced for the FIBC mode, and the extra indication flag may be signaled after an IBC-local illumination compensation (LIC) flag. In an example, when the IBC-LIC flag is true, the FIBC flag may be signaled and used to indicate whether the FIBC mode is applied to the current block or not.

In the FIBC mode described above, a filtered IBC model may be used where the prediction samples of the IBC mode are enhanced by applying a linear filter. Up to 4 lines/columns of samples above and left to the current CU may be applied to derive the filter coefficients. In various example, the design of the filter in the FIBC such as described in Eq. 7 may not be accurate enough since the filter only consists of a linear term of sample values and does not use additional information such as the gradient information and location information. Further, the filter in the FIBC mode described above does not include a nonlinear term.

Aspects of the disclosure provide techniques to improve the FIBC mode by including at least one of gradient information, location information, a nonlinear term, and/or the like when deriving filter coefficients for the FIBC mode.

The methods, aspects, and examples described in the disclosure may be used separately or combined in any order. The term “the IBC mode” may refer to the IBC mode described in the disclosure or a variant. The term “the IntraTMP mode” may refer to the IntraTMP mode described in the disclosure or a variant. Further, the methods, aspects, and examples may be implemented by processing circuitry (e.g., one or more processors or one or more integrated circuits). In one example, the one or more processors execute a program that is stored in a non-transitory computer-readable medium.

FIG. 7B shows an example of the modification of the FIBC mode according to an aspect of the disclosure. A current block (701) in a current picture (700) may be predicted using one of the IBC mode and the IntraTMP mode. In an example, a BV (702) is determined using the one of the IBC mode and the IntraTMP mode. The BV (702) may indicate a reference block (703) of the current block (701). The reference block (703) is in the current picture (700) and may be already reconstructed. Reference samples in the reference block (703) are already reconstructed, and may be used to predict the current block (701). Thus, the reference samples in the reference block (703) may be referred to as the IBC prediction samples. According to an aspect of the disclosure, in the FIBC mode (e.g., the updated FIBC mode that is modified from the FIBC mode described in Eq. 7), the IBC prediction samples may be filtered by the FIBC filter. Thus, the filtered reference block (703) may be generated and may include the IBC prediction samples that are filtered by the FIBC filter. Current samples in the current block (701) may be predicted using the IBC prediction samples that are filtered by the FIBC filter.

Referring to FIG. 7B, in an example, a current sample (710) in the current block (701) is to be predicted using the FIBC mode that is updated based on the additional information (e.g., the gradient information, the location information, and/or the nonlinear term). A reference sample (711) in the reference block (703) corresponds the current sample (710), e.g., the BV (702) indicates a displacement between the reference sample (711) and the current sample (710). The current sample (710) may be predicted using the IBC prediction sample (711) that is filtered by the FIBC filter. After being filtered by the FIBC filter, the reference sample (711) may be referred to as the FIBC filtered prediction sample (711). For example, a predicted value of the current sample (710) is a value of the FIBC filtered prediction sample (711). The value of the FIBC filtered prediction sample may also be referred to as a predicted value because, for example, this value may be used directly as the predicted value for the current sample (710).

In an aspect, in addition to a linear filter that may be similar or identical to the filter in Eq. 7, the FIBC filter may further include one or more of (i) at least one gradient filter (e.g., indicating gradient information associated with the respective IBC prediction samples), (ii) a location filter (e.g., indicating location information associated with the linear filter), (iii) a nonlinear term (also referred to as a nonlinear value) associated with the respective IBC prediction samples, and/or the like.

Coefficients (also referred to as filter coefficients) of the FIBC filter may include linear coefficients for the linear filter and one or more of (i) gradient coefficients for the at least one gradient filter, (ii) location coefficients for the location filter, (iii) nonlinear coefficient(s) for the nonlinear term, and the like. If other information is included in the FIBC filter, additional coefficients may be included in the filter coefficients of the FIBC filter.

In an aspect, the coefficients of the FIBC filter may be determined from a current template (704) of the current block (701) and a reference template (705) of the reference block (703).

Details of the methods, aspects, and examples of the FIBC mode using the FIBC filter are described as follows.

In an aspect, the IBC prediction samples may be filtered by utilizing the gradient information including gradients (Gx, Gy) of neighboring reconstructed samples. A predicted value pred0(x,y) at (x,y) may be determined (e.g., defined) using Eqs. 8-12.

$$pred 0 ( x , y ) = P 0 + G X + GY + B \qquad Eq . 8$$

$$P 0 = {\sum }_{i = 1}^{N 0} ( {c}_{0 , i} \times t ( x - {xoffset}_{0 , i} , y - {yoffset}_{0 , i} ) ) \qquad Eq . 9$$

$$GX = {\sum }_{j = 1}^{N 1} ( {c}_{1 , j} \times {G}_{x} ( x - {xoffset}_{1 , j} , y - {yoffset}_{1 , j} ) ) \qquad Eq . 10$$

$$GY = {\sum }_{k = 1}^{N 2} ( {c}_{2 , k} \times {G}_{y} ( x - {xoffset}_{2 , k} , y - {yoffset}_{2 , k} ) ) \qquad Eq . 11$$

$$B = {\sum }_{l = 1}^{N 3} ( {c}_{3 , l} \times {b}_{l} ) \qquad Eq . 12$$

pred0(x,y) may be the predicted value at (x,y). Four sets of parameters associated with P0, GX, GY, and B may correspond to the input sample values, horizontal gradient information, vertical gradient information, and a bias, respectively. P0 may be a linear predicted value obtained using the linear filter such as described in Eq. 9. GX may be a horizontal gradient value obtained using a horizontal gradient filter such as described in Eq. 10. GY may be a vertical gradient value obtained using a vertical gradient filter such as described in Eq. 11. B may be a bias term, such as described in Eq. 12. In an example, a linear filter may include the bias term. In the example indicated by Eq. 8, the at least one gradient filter may include the horizontal gradient filter and the vertical gradient filter.

In an example, the current sample (710) is at the position (x,y) in the current block (701). The reference sample or the IBC prediction sample (711) may be at the same position (x,y) in the reference block (703). The predicted value pred0(x,y) at the position (x,y) may be determined by applying the FIBC filter such as described in Eqs. 8-12 to the IBC prediction sample (711) at (x,y).

Reconstructed samples located at positions (x−xoffset_{0,i},y−yoffset_{0,i}) in the reference block (703) may be referred to as first input samples or N0 input samples where i is from 1 to N0. Reconstructed samples located at positions (x−xoffset_{1,j},y−yoffset_{1,j}) in the reference block (703) may be referred to as second input samples or N1 input samples where j is from 1 to N1. Reconstructed samples located at positions (x−xoffset_{2,k},y−yoffset_{2,k}) may be referred to as third input samples or N2 input samples where k is from 1 to N2. The N0 input samples, the N1 input samples, and the N2 input samples may be used to obtain the predicted value pred0(x,y). The N0 input samples, the N1 input samples, and the N2 input samples may include (i) neighboring reconstructed samples of the reference sample (711), such as samples N, S, W, and E in the reference block (703) as shown in FIG. 7B, (ii) reconstructed samples that are not adjacent to the reference samples (711), and/or the like. After the predicted value pred0(x,y) is determined, for example, for the reference sample (711), the current sample (710) may be predicted based on the predicted value pred0(x,y). For example, the predicted value of the current sample (710) is equal to pred0(x,y). The current sample (710) may be reconstructed based on the predicted value of the current sample (710).

The first set or the first set of parameters may be related to sample values (e.g., the N1 input sample values), which may include parameters (e.g., including the coefficients c_{0,i}) for the N0 input samples. (x−xoffset_{0,i},y−yoffset_{0,i}) is the position of the i^{th} input sample, c_{0,i} is the coefficient for the i^{th} input sample, and t(x−xoffset_{0,i},y−yoffset_{0,i}) is the value for the i^{th} input sample.

The linear filter used in the FIBC filter may be based on the coefficients c_{0,i} and the positions of the N0 input samples. The linear coefficients may include the coefficients {c_{0,i}}. A shape of the linear filter may be based on offsets {(xoffset_{0,i},yoffset_{0,i})} with respect to a reference location, such as (x,y).

Referring to FIG. 7B, if the N0 input samples include the N, S, W, and E samples in the reference block (703), N0 is 4. If the N0 input samples include the samples N, S, W, E, and (711) in the reference block (703), N0 is 5. For the N sample, xoffset_{0,i} is 0, and yoffset_{0,i} is −1.

The second set or the second set of parameters may be related to the horizontal gradient information, which may include parameters for the N1 input sample(s). c_{1,j} is the coefficient for the j^{th} input sample, Gₓ(x−xoffset_{1,j},y−yoffset_{1,j}) is the value of the horizontal gradient Gₓ for the j^{th} input sample. In an example, the N1 input sample(s) may be identical to the N0 input samples. In an example, the N1 input sample(s) may be different from the N0 input samples.

The horizontal gradient filter used in the FIBC filter may be based on the coefficients c_{1,j} and the positions of the N1 input samples. The horizontal gradient coefficients may include the coefficients {c_{1,j}}. A shape of the horizontal gradient filter may be based on offsets {(x−xoffset_{1,j},y−yoffset_{1,j})} with respect to a reference location, such as (x,y).

The third set or the third set of parameters may be related to the vertical gradient information, which may include parameters for the N2 input sample(s). c_{2,k} is the coefficient for the k^{th} input sample, G_{y}(x−xoffset_{2,k},y−yoffset_{2,k}) is the value of the vertical gradient G_{y} for the kth input sample. In an example, the N2 input sample(s) may be identical to the N0 input samples. In an example, the N2 input sample(s) may be different from the N0 input samples. In an example, the N2 input sample(s) may be identical to the N1 input samples. In an example, the N2 input sample(s) may be different from the N1 input samples.

The vertical gradient filter may be based on the coefficients c_{2,k} and the positions of the N2 input samples. The vertical gradient coefficients may include the coefficients {c_{2,k}}. A shape of the vertical gradient filter may be based on offsets {(x−xoffset_{2,k},y−yoffset_{2,k})} with respect to a reference location, such as (x,y).

The fourth set or the third set of parameters may be related to the bias B, and thus may include parameters for the respective biases bₗ. bₗ is the l^{th} bias. c₃₁ is the coefficient for the l^{th} bias bₗ. In an example, N3 can be zero and the predicted value pred0(x,y) does not include the bias. In an example, the linear filter may include bias B.

According to an aspect of the disclosure, the linear predicted value of the current sample in the current block may be determined by applying the linear filter to prediction samples that are predicted using the one of an IBC mode and an intra template matching (IntraTMP) mode, such as described in Eq. 9. A gradient value associated with the current sample in the current block may be determined using at least one gradient filter, such as the horizontal gradient filter and/or the vertical gradient filter, such as described in Eqs. 10-11. The predicted value of the current sample may be determined based on a sum of the linear predicted value and at least one modification value that includes the gradient value. The gradient value is based on at least one of GX and GY. The FIBC filter in the FIBC mode may include the linear filter and the at least one gradient filter. The current sample may be reconstructed from the predicted value of the current sample.

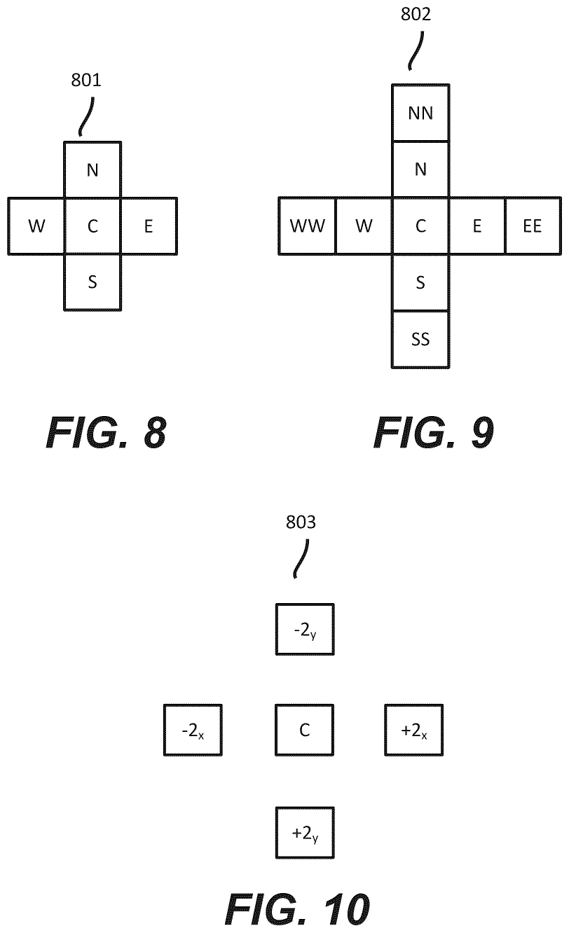

In an aspect, the available filters in the FIBC mode may have any suitable shapes and/or sizes. In an example, the linear filter has a cross-shape that includes 5 samples that include a center sample of the linear filter with an offset of (0, 0), a North sample N with an offset of (0, −1), a South sample S with an offset of (0, 1), an East sample E with an offset of (1, 0), and a West sample W with an offset of (−1, 0), such as shown in FIG. 8. The offsets of the 5 samples in the linear filter are with respect to the center sample. When the linear filter has the 5 samples, the current sample may be located at one of 5 positions of the respective 5 samples.

In an example, the linear filter has a cross-shape that includes: 9 samples that include a center sample of the linear filter with an offset of (0, 0), two North samples with respective offsets of (0, −1) and (0, −2), two South samples with respective offsets of (0, 1) and (0, 2), two East samples with respective offsets of (1, 0) and (2, 0), and two West samples with respective offsets of (−1, 0) and (−2, 0), such as shown in FIG. 9. The offsets of the 9 samples in the linear filter are with respect to the center sample. When the linear filter has the 9 samples, the current sample is located at one of 9 positions of the respective 9 samples.

FIGS. 8-10 show examples of available filters in the FIBC mode according to aspects of the disclosure. In an example, the available filters include cross-shaped filters (801)-(802) shown in FIGS. 8-9. In the example shown in FIG. 8, when the filter (801) is applied to the N0 input samples, N0 is 5, and the five samples (e.g., the five input samples) include:
a Center sample (C) where c_{0,i} is the coefficient for C, xoffset_{0,i}=0, yoffset_{0,y}=0 (e.g., i=1);
a North sample (N) where c_{0,i} is the coefficient for N, xoffset_{0,i}=0, yoffset_{0,i}=−1 (e.g., i=2);
a South sample (S) where c_{0,i} is the coefficient for S, xoffset_{0,i}=0, yoffset_{0,i}=1 (e.g., i=3);
an East sample (E) where c_{0,i} is the coefficient for E, xoffset_{0,i}=1, yoffset_{0,i}=0 (e.g., i=4); and
a West sample (W) where c_{0,i} is the coefficient for W, xoffset_{0,i}=−1, yoffset_{0,i}=0 (e.g., i=5).

The filter shape (802) shown in FIG. 9 may be interpreted in a similar way as that of the filter (801). For example, if the filter shape (802) is applied to the N0 input samples, N0 is 9 and the N0 input samples include C, N, S, E, W which are identical to the samples (e.g., C, N, S, E, and W) described in FIG. 8. The N0 input samples in FIG. 9 further includes samples NN, SS, EE, and WW. In an example, the NN sample has an offset of (0, −2).

In the above examples such as in FIGS. 8-9, the position of the current sample and the position of the corresponding reference sample may be located at the center sample of the filter (e.g., (801) or (802)), and thus the offset for the center sample of the filter (e.g., (801) or (802)) is (0, 0) with respect to (x,y). The position of the current sample and the position of the corresponding reference sample may not be limited to the position (e.g., the center position) shown in the examples, and other input samples can be used as the reference sample or the current sample). Referring to the filter (801) in FIG. 8, the current sample or the corresponding reference sample may be located at one of the 5 positions of the respective 5 input samples (e.g., C, N, S, E, or W). In an example, the reference sample is located at N, and thus the offset for N is (0, 0) with respect to (x,y), the offset for C is (0, 1), and the offsets for other samples are shifted accordingly. Referring to the filter (802) in FIG. 9, the current sample or the corresponding reference sample may be located at one of the 9 positions of the respective 9 input samples. In an example, the reference sample corresponding to the current sample is located at W, and thus the offset for W is (0, 0), the offset for C is (1, 0), and the offsets for other samples are shifted accordingly.

In an aspect, the allowed value of the offset (e.g., indicated by xoffset and yoffset) may be predefined for each sample i (e.g., each one of the N0 input samples), for each Gₓ element j, and for each G_{y} element k for the first set of parameters, the second set of parameters, and the third set of parameter sets associated with P0, GX, GY, respectively. In an example, the positions of the N0 input samples are predefined. Thus, the shape of the linear filter is predefined. One or more shapes of the at least one gradient filter are predefined. In an example, the positions of the N1 input samples and thus the shape of the horizontal gradient filter are predefined. In an example, the positions of the N2 input samples and thus the shape of the vertical gradient filter are predefined.

In an aspect, the distribution of the current sample and neighboring samples of the current sample defined by (x-xoffset, y-yoffset) does not have to be consecutive. As described above, the position of the current sample in the current block and the position of the corresponding reference sample in the reference block are (x,y), and the distribution of the reference sample and neighboring samples of the reference sample is defined by (x-xoffset, y-yoffset), and does not have to be consecutive. In an example, an input sample in one of the linear filter, the horizontal gradient filter, and the vertical gradient filter is spatially separated from all remaining input samples in the one of the linear filter, the horizontal gradient filter, and the vertical gradient filter. For example, a sample in the linear filter is spatially separated from all remaining samples in the linear filter.

In an example, none of input samples in one of the linear filter, the horizontal gradient filter, and the vertical gradient filter is spatially adjacent to another input sample in the one of the linear filter, the horizontal gradient filter, and the vertical gradient filter, such as shown in FIG. 10.

FIG. 10 shows an example of a filter shape (803) without consecutive samples according to an aspect of the disclosure. The filter shape or the filter (803) can include 5 input samples located at C, +2ₓ, −2ₓ, +2_{y}, and −2_{y}. Each of the 4 sample positions (e.g., +2ₓ, −2ₓ, +2_{y}, and −2_{y}) is shifted 2 samples from C, and thus the offset is 2, and x/y are the direction indicators. For example, the location +2ₓ has an offset (+2, 0) from C. The filter shape (803) may be used to derive P0, GX, and/or GY.

In an aspect, several variants of the linear predicted value P0 may be used. For example, the mean removal operation can be applied to P0 when feeding the inputs (e.g., the N0 input samples) to the FIBC input reference samples. P1 denotes a variant of the linear predicted value which may be P0 with the mean removal operation applied such as described in Eq. 13. The mean removal operation may be similar to the method used in CCCM. Then the predicted value pred1(x,y) of (x,y) can be generated using Eqs. 13-14.

$$Eq . 13$$

$$P 1 = ( {\sum }_{i = 0}^{N 0} ( {c}_{0 , i} \times ( t ( x - {xoffset}_{0 , i} , y - {yoffset}_{0 , i} ) - mean ) ) ) + mean$$

$$pred 1 ( x , y ) = P 1 + G X + GY \qquad Eq . 14$$

In an example, the linear filter (described in Eq. 13) adds a mean value (e.g., mean in Eq. 13) of the current block and removes the mean value of the current block from each of the samples (e.g., the IBC prediction samples t(x−xoffset_{0,i},y−yoffset_{0,i})) that are predicted using the one of the IBC mode and the IntraTMP mode.

In an example, the clipping operation can be applied to generate the final prediction pred2(x,y).

$$p r e d 2 ( x , y ) = clip ( min , max , pred i ( x , y ) ) \qquad Eq . 15$$

The min value and the max value may be the minimal value and the maximal value of samples in the template, respectively. predi(x,y) may be pred0(x,y), pred1(x,y), or the like. In an example, the predicted value predi(x,y) of the current sample may be clipped such as shown in Eq. 15.

Details related to the gradient information are further described below.

The number and positions for different set of parameters can be set independently. In an example, N0 and the positions of the N0 input samples are set independently. In an example, N1 and the positions of the N1 input samples are set independently. In an example, N2 and the positions of the N2 input samples are set independently. In an example, the linear filter, the horizontal gradient filter, and the vertical gradient filter may be set independently.

In an aspect, both GX and GY can be used as inputs to the filter in the FIBC mode, N1 is equal to N2, and the same sample positions are used as the inputs to both set. In an example, the horizontal gradient filter and the vertical gradient filter have the same size and the same shape.

In an example, when the at least one gradient filter includes the horizontal gradient filter and the vertical gradient filter, the gradient value is a sum of a horizontal gradient value (e.g., GX) and a vertical gradient value (e.g., GY), and the number N1 of the first input samples (e.g., the N1 input samples) and the positions of the first input samples in the horizontal gradient filter and the number N2 of the second input samples (e.g., the N2 input samples) and the positions of the second input samples in the vertical gradient filter are set independently from each other and from the linear filter (e.g., based on N0 and the N0 input samples).

In an aspect, both GX and GY can be used as inputs to the filter in the FIBC mode, N1 is equal to N2, but different sample positions are used as the inputs for GX and GY, respectively. In an example, the positions of the first input samples (e.g., the N1 input samples) in the horizontal gradient filter and the positions of the second input samples (e.g., the N2 input samples) in the vertical gradient filter are different. For example, the horizontal gradient filter and the vertical gradient filter have the same size and different shapes.

When the at least one gradient filter consists of the horizontal gradient filter, the gradient value is the horizontal gradient value, and a number N1 of first input samples and positions of the first input samples in the horizontal gradient filter are set independently from the linear filter.

In an aspect, only GX can be used as the input to the filter in the FIBC mode. In an example, when the at least one gradient filter consists of a horizontal gradient filter, the gradient value is a horizontal gradient value (e.g., GX), and a number N1 of first input samples (e.g., the N1 input samples) and positions of the first input samples in the horizontal gradient filter are set independently from the linear filter (e.g., based on N0 and the N0 input samples). For example, pred0(x,y)=P0+GX or pred1(x,y)=P1+GX.

When the at least one gradient filter consists of a vertical gradient filter, the gradient value is a vertical gradient value, and a number of second input samples and positions of the second input samples in the vertical gradient filter are set independently from the linear filter.

In an aspect, only GY can be used as the input to the filter in the FIBC mode. In an example, when the at least one gradient filter consists of a vertical gradient filter, the gradient value is a vertical gradient value (e.g., GY), and a number N2 of second input samples (e.g., the N2 input samples) and positions of the second input samples in the vertical gradient filter are set independently from the linear filter (e.g., based on N0 and the N0 input samples). For example, pred0(x,y)=P0+GY or pred1(x,y)=P1+GY.

The gradient value may be determined based on at least one of the horizontal gradient value (GX) that is determined based on horizontal gradients (Gₓ) of the respective first input samples (e.g., the N1 input samples) or the vertical gradient value (GY) that is determined based on vertical gradients G_{y} of the respective second input samples (e.g., the N2 input samples), such as shown in Eqs. 8, 10, and 11.

A gradient associated with an input sample, such as a horizontal gradient Gₓ or a vertical gradient G_{y}, may be calculated using any suitable method. Some examples are described below.

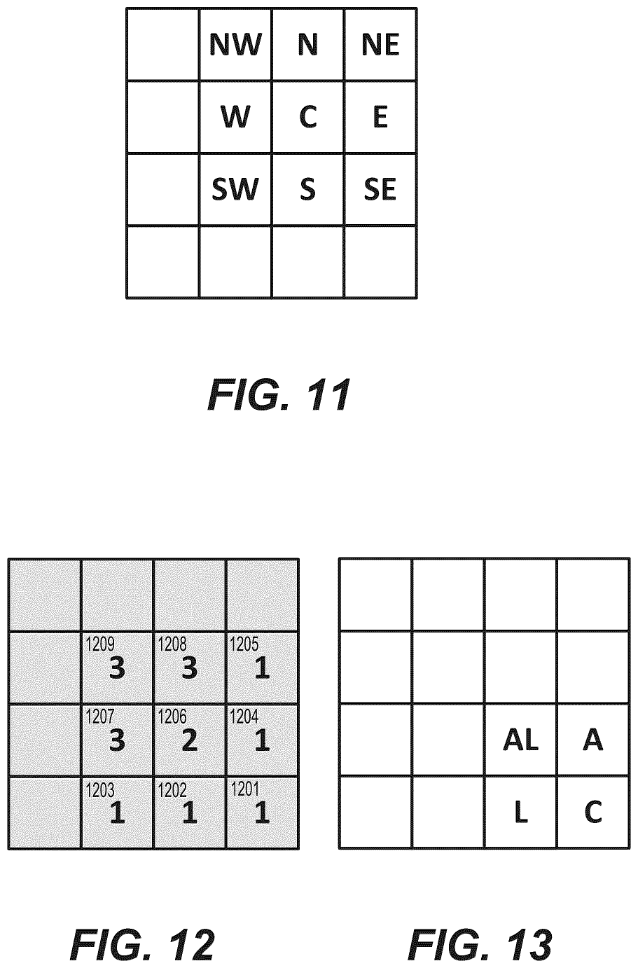

FIG. 11 shows an example of neighboring samples of an input sample C used for calculating the gradients according to an aspect of the disclosure. Given the input sample C and the neighboring samples (e.g., indicated using “N”, “S”, “E”, “W”, “NW”, “NE”, “SW”, and “SE” such as described above in FIGS. 8-9) of the input sample C, the individual gradient such as Gₓ and G_{y} may be calculated as below.

In an aspect, Gₓ and G_{y} are calculated based on the samples C, W and N:

$${G}_{y} = ( C - N ) \qquad Eq . 16$$

$${G}_{x} = ( C - W )$$

In an aspect, Gₓ and G_{y} may be calculated based on the samples N, S, W, and E.

$${G}_{y} = ( N - S ) \qquad Eq . 17$$

$${G}_{x} = ( W - E )$$

In an aspect, Gₓ and G_{y} may be calculated based N, S, W, E, NW, SW, NE, and SE.

$${G}_{y} = ( 2 N + N W + N E ) - ( 2 S + S W + SE ) \qquad Eq . 18$$

$${G}_{x} = ( 2 W + N W + S W ) - ( 2 E + NE + SE )$$

In an aspect, the at least one gradient filter includes a horizontal gradient filter. The gradient value includes a horizontal gradient value (e.g., GX) that is a sum of horizontal gradients Gₓ of respective first input samples in the horizontal gradient filter (e.g., Eq. 10). Each horizontal gradient of the respective first input samples may be determined based on one of: (i) a difference between the respective first input sample and a left neighbor of the respective first input sample (e.g., Eq. 16); (ii) a difference between the left neighbor of the first input sample and a right neighbor of the respective first input sample (e.g., Eq. 17); and (iii) a difference between a first value (2 W+NW+SW) and a second value (2E+NE+SE), such as shown in Eq. 18. The first value is a weighted sum based on a top-left neighbor, the left neighbor, and a bottom-left neighbor of the first input sample. The second value is a weighted sum based on a top-right neighbor, the right neighbor, and a bottom-right neighbor of the first input sample.

Which of the differences is used to calculate the horizontal gradient of the respective first input sample may be determined based on a position of the respective first input sample.

In an example, the at least one gradient filter includes a vertical gradient filter. The gradient value includes a vertical gradient value that is a sum of vertical gradients of respective second input sample in the vertical gradient filter (e.g., Eq. 11). Each vertical gradient of the respective second input sample may be determined based on one of: (i) a difference between the respective second input sample and a top neighbor of the respective second input sample; (ii) a difference between the top neighbor of the respective second input sample and a bottom neighbor of the respective second input sample; and (iii) a difference between a first value and a second value, such as shown in Eq. 18. The first value is a weighted sum based on a top-left neighbor, the top neighbor, and a top-right neighbor of the second input sample. The second value is a weighted a sum based on bottom-left neighbor, the bottom neighbor, and a bottom-right neighbor of the respective second input sample.

Which of the differences is used to calculate the vertical gradient of the respective second input sample is determined based on a position of the respective second input sample.

In an aspect, Gₓ and G_{y} may be calculated depending on a position of the input sample C. FIG. 12 shows an example of choosing a gradient calculation method (e.g., one of the methods described with Eqs. 16-18) based on the location of the input sample according to an aspect of the disclosure. The gradients {Gₓ, G_{y}} of input samples (e.g., input samples (1201)-(1209)) may be calculated using different gradient calculation methods depending on the locations of the input samples.

The input samples (1201)-(1205) are located at a type 1 location. For each of the input samples (1201)-(1205) at the type 1 location, the samples C, W, and N for the respective input sample may be used to calculate Gₓ and G_{y} for the input sample, for example, using Eq. 16. For example, the samples C, W, and N for the input sample (1202) may be the samples (1202), (1203), and (1206), respectively. For example, the samples C, W, and N for the input sample (1204) may be the samples (1204), (1206), and (1205), respectively.

The input sample (1206) is located at a type 2 location. The samples N, S, W, and E may be used to calculate Gₓ and G_{y} for the input sample (1206) at the type 2 location, for example, using Eq. 17.

The input samples (1207)-(1209) are located at a type 3 location. For each of the input samples (1207)-(1209) at the type 3 location, the corresponding samples N, S, W, E, NW, SW, NE, and SE for the respective input sample may be used to calculate Gₓ and G_{y} for the input sample, for example, using Eq. 18.

The IBC prediction samples may be filtered by utilizing the location of a center luma sample. In an example, the center luma sample is within the filter, such as the filter (801), the filter (802), the filter (803), or the like. In an example, the center luma sample is within the linear filter, such as the filter (801), the filter (802), the filter (803), or the like. The position of the center luma sample may move when the filter is applied for each input sample. Referring to FIG. 8, the center luma sample may be the position of C.

In an aspect, the prediction value including but is not limited to pred0(x,y) or pred1(x,y). The prediction value may be further refined by adding the information of the coordinate of the center luma sample using Eq. 19.

$$\overline{pred ( x , y )} = predi ( x , y ) + L X + LY \qquad Eq . 19$$

predi(x,y) may be the original prediction (e.g., the predicted value without the location information) including but is not limited to pred0(x,y), pred1(x,y), or the like. LX and LY may be the location information of the center luma sample in the horizontal direction and the vertical direction, respectively. LX and LY may be obtained (e.g., defined) using Eq. 20.

$$L X = {c}_{4} X \qquad Eq . 20$$

$$LY = {c}_{5} Y$$

c₄ and c₅ are the coefficients for the location information, and X and Y parameters are the spatial coordinates of the center luma sample.

As described in Eq. 20, a location value (e.g., LX+LY) may be determined using the location of the center sample that is at the center of a filter (e.g., the linear filter).

Based on Eq. 19, when predi(x,y)=pred0(x,y), p̅r̅e̅d̅(̅x̅,̅y̅)̅=pred0(x,y)+LX+LY, and thus p̅r̅e̅d̅(̅x̅,̅y̅)̅=P0+GX+GY+B+LX+LY. If B is 0, then p̅r̅e̅d̅(̅x̅,̅y̅)̅=P0+GX+GY+LX+LY.

Based on Eq. 19, when predi(x,y)=pred1(x,y), p̅r̅e̅d̅(̅x̅,̅y̅)̅=pred1(x,y)+LX+LY, and thus p̅r̅e̅d̅(̅x̅,̅y̅)̅=P1+GX+GY+LX+LY.

Thus, the predicted value p̅r̅e̅d̅(̅x̅,̅y̅)̅ of the current sample may be determined based on a sum of the linear predicted value (e.g., P0 or P1) and the at least one modification value that includes the gradient value (e.g., GX+GY) and the location value (e.g., LX+LY). The FIBC filter in the FIBC mode includes the linear filter (e.g., for P0 or P1), the at least one gradient filter (e.g., for GX and/or GY), and the coefficients (e.g., c₄ and c₅) for the location.

The IBC prediction samples may be filtered by utilizing a nonlinear term derived from the neighboring reconstructed samples.

In an aspect, the prediction value predi(x,y) can be further refined by adding a nonlinear term (also referred to as a nonlinear value) NP using Eq. 21.

$$\overline{pred ( x , y )} = predi ( x , y ) + {c}_{6} NP \qquad Eq . 21$$

predi(x,y) is the original prediction (e.g., the predicted value without the location information) including but not limited to pred0(x,y), pred1(x,y), or the like. In an example, the refined prediction p̅r̅e̅d̅(̅x̅,̅y̅)̅ may be obtained based on the predicted value predi(x,y) (e.g., pred0(x,y), pred1(x,y), or the like) and the nonlinear term using Eq. 21.

In one example, the nonlinear term is generated from an original predicted value of the current predicted sample using Eq. 22.

$$N P = ( C \times C + midVal ) ≫ bitDepth \qquad Eq . 22$$

C in Eq. 22 may be the original predicted value of the current sample, which may be the IBC predicted value of the current sample obtained from the one of the IBC mode and the IntraTMP mode. Thus, C in Eq. 22 may be the value of the reference sample (the IBC prediction sample) without the FIBC filter.

In an example, the middle value (midVal) for 10-bit content is 2¹⁰/2, which is 512. Thus, for 10-bit content the nonlinear term NP may be calculated as using Eq. 23.

$$N P = ( C \times C + 512 ) ≫ 10 \qquad Eq . 23$$

The clipping operation can then be applied to generate the final prediction pred2(x,y) using Eq. 24.

$$p r e d 2 ( x , y ) = clip ( min , max , \overline{pred ( x , y )} ) \qquad Eq . 24$$

In another example, the nonlinear term may be generated from the current sample and reconstructed or previously predicted values in the immediate neighborhood of the current predicted sample. FIG. 13 shows an example of locations of the samples A, L, and AL, respectively according to an aspect of the disclosure. The samples A, L, and AL are neighboring samples of the current sample C. M1 may be a mean of values of the samples A, L, AL, and C, such as M1=mean (A, L, AL, C). M1 may be a median of values of the samples A, L, AL, and C, such as M1=median (A, L, AL, C). The nonlinear term NP is defined using Eq. 25

$$N P = ( M 1 \times M 1 + midVal ) ≫ bitDepth \qquad Eq . 25$$

In another example, the nonlinear term may be generated from reconstructed or previously predicted values in the immediate neighborhood of the current predicted sample. The non-linear term NP is defined using Eq. 26.

$$N P = ( M 2 \times M 2 + midVal ) ≫ bitDepth \qquad Eq . 26$$

M2 may be a mean of values of the samples A, L, and AL, such as M2=mean (A, L, AL). M2 may be a median of values of the samples A, L, and AL, such as M2=median (A, L, AL).

The nonlinear value or the nonlinear term NP associated with the current sample may be determined from at least one of the current sample (e.g., C in FIG. 13) and neighboring samples (e.g., A, L, AL in FIG. 13) of the current sample using a nonlinear relationship (e.g., Eqs. 23, 25, and 26) between the nonlinear value NP and values of the at least one of the current sample and the neighboring samples (e.g., C, A, L, and AL). The predicted value pred(x,y) of the current sample may be determined based on a sum of the linear predicted value (e.g., P0 or P1) and the at least one modification value that includes the gradient value (e.g., GX+GY) and the nonlinear value NP. The FIBC filter in the FIBC mode includes the linear filter, the at least one gradient filter, and a coefficient (e.g., c) for the nonlinear value.

In an aspect, the coefficients (e.g., the filter coefficients of the FIBC filter) are derived from the template (e.g., the current template) of the coding block (e.g., the current block) and a corresponding reference template. Referring back to FIG. 7B, in as aspect, the filter coefficients of the FIBC filter may be determined based on the current template (704) of the current block (701) and the reference template (705) of the reference block (703). In an example, up to 4 lines and 4 columns of samples above and left to the current block (701) may be applied to derive the filter coefficients of the FIBC filter.

In an aspect, the filter coefficients of the FIBC filter include the linear filter coefficients {c_{0,i}} of the linear filter and one or more of (i) the gradient filter coefficients {c_{1,j}} for the horizontal gradient filter and/or {c_{2,k}} for the vertical gradient filter, (ii) the location coefficients c₄ and c₅ for the location filter, and (iii) the nonlinear coefficient c₆ for the nonlinear term. In an example, if the bias B is included, the filter coefficients include {c_{3,l}}. In an example, the linear filter includes {c_{3,l}}. If other information is included in the FIBC filter, additional coefficients may be included in the filter coefficients of the FIBC filter.

The filter coefficients of the FIBC filter may be determined (e.g., derived) based on the current template (704) of the current block (701) and the reference template (705) of the reference block (703). In the example shown in FIG. 7B, the current template (704) includes 4 rows above the current block (701) and 4 columns to the left of the current block (701). Samples in the current template (704) are already reconstructed. Prediction samples of the respective samples in the current template (704) may be generated by applying the FIBC filter (e.g., described by one or more of Eqs. 8-15, 19, and 21) to corresponding samples in the reference template (705). The filter coefficients are determined, for example, by minimizing an error function (e.g., MSE) between the predicted samples and the reconstructed samples in the current template, such as used in CCCM.

In an aspect, the coefficients are determined (e.g., derived) using LDL method (also referred to as the LDL decomposition) as used in the CCCM, or a variance. In the LDL decomposition, a matrix A may be decomposed as A=LDL^{T}. L is a lower unit triangular (unitriangular) matrix, D is a diagonal matrix, and L^{T} is a transpose of L. The LDL decomposition may be a closely related variant of the Cholesky decomposition. In some examples, the LDL decomposition may be advantageous over Cholesky decomposition as the LDL decomposition may avoid extracting square roots.

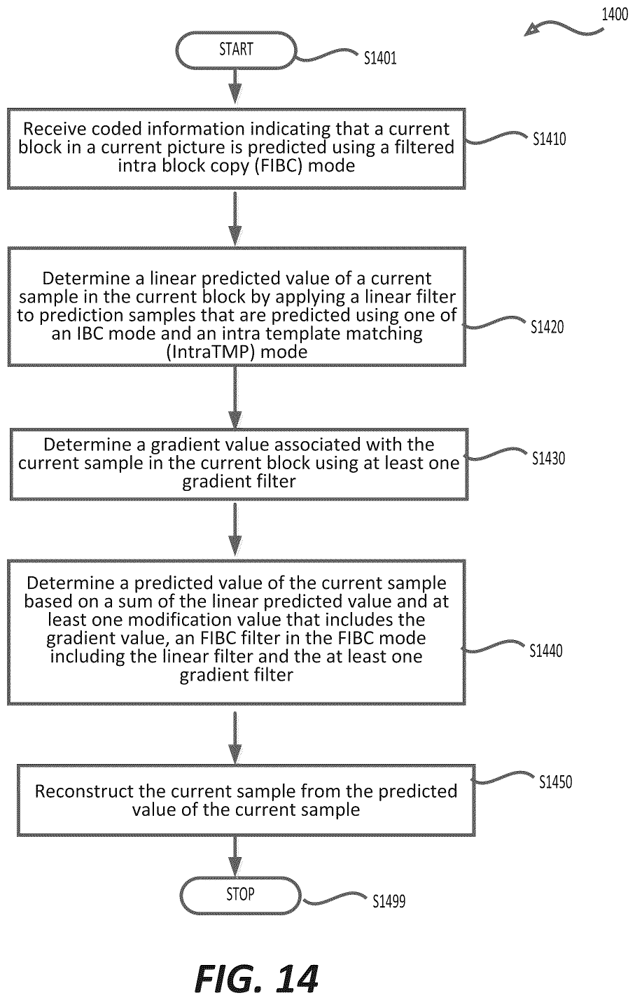

FIG. 14 shows a flow chart outlining a process (1400) according to an aspect of the disclosure. The process (1400) can be used in an apparatus, such as a video decoder. In various aspects, the process (1400) is executed by processing circuitry, such as the processing circuitry that performs functions of the video decoder (110), the processing circuitry that performs functions of the video decoder (210), and the like. In some aspects, the process (1400) is implemented in software instructions, thus when the processing circuitry executes the software instructions, the processing circuitry performs the process (1400). The process starts at (S1401) and proceeds to (S1410).

At (S1410), coded information indicating that a current block in a current picture is predicted using a filtered intra block copy (FIBC) mode is received.

At (S1420), a linear predicted value of a current sample in the current block is determined by applying a linear filter to prediction samples that are predicted using one of an IBC mode and an intra template matching (IntraTMP) mode.

In an example, the linear filter includes a bias term.

In an example, the linear filter adds a mean value of the current block and removes the mean value of the current block from each of the samples that are predicted using the one of the IBC mode and the IntraTMP mode.

In an example, the linear filter has a cross-shape that includes: (i) 5 samples that include a center sample of the linear filter with an offset of (0, 0), a North sample N with an offset of (0, −1), a South sample S with an offset of (0, 1), an East sample E with an offset of (1, 0), and a West sample W with an offset of (−1, 0), the offsets of the 5 samples in the linear filter are with respect to the center sample; or (ii) 9 samples that include a center sample of the linear filter with an offset of (0, 0), two North samples with respective offsets of (0, −1) and (0, −2), two South samples with respective offsets of (0, 1) and (0, 2), two East samples with respective offsets of (1, 0) and (2, 0), and two West samples with respective offsets of (−1, 0) and (−2, 0), the offsets of the 9 samples in the linear filter are with respect to the center sample.

When the linear filter has the 5 samples, the current sample is located at one of 5 positions of the respective 5 samples. When the linear filter has the 9 samples, the current sample is located at one of 9 positions of the respective 9 samples.

At (S1430), a gradient value associated with the current sample in the current block is determined using at least one gradient filter.

In an example, when the at least one gradient filter consists of a horizontal gradient filter, the gradient value is a horizontal gradient value, and a number of first input samples and positions of the first input samples in the horizontal gradient filter are set independently from the linear filter. When the at least one gradient filter consists of a vertical gradient filter, the gradient value is a vertical gradient value, and a number of second input samples and positions of the second input samples in the vertical gradient filter are set independently from the linear filter. When the at least one gradient filter includes a horizontal gradient filter and a vertical gradient filter, the gradient value is a sum of a horizontal gradient value and a vertical gradient value, and the number of the first input samples and the positions of the first input samples in the horizontal gradient filter and the number of the second input samples and the positions of the second input samples in the vertical gradient filter are set independently from each other and from the linear filter.

In an example, the at least one gradient filter includes a horizontal gradient filter. The gradient value includes a horizontal gradient value that is a sum of horizontal gradients of respective first input samples in the horizontal gradient filter. Each horizontal gradient of the respective first input samples is determined based on one of: (i) a difference between the respective first input sample and a left neighbor of the respective first input sample; (ii) a difference between the left neighbor of the first input sample and a right neighbor of the respective first input sample; and (iii) a difference between a first value and a second value, the first value being a sum based on a top-left neighbor, the left neighbor, and a bottom-left neighbor of the first input sample, the second value being a sum based on a top-right neighbor, the right neighbor, and a bottom-right neighbor of the first input sample.

In an example, which of the differences is used to calculate the horizontal gradient of the respective first input sample is determined based on a position of the respective first input sample.

In an example, the at least one gradient filter includes a vertical gradient filter. The gradient value includes a vertical gradient value that is a sum of vertical gradients of respective second input sample in the vertical gradient filter. Each vertical gradient of the respective second input sample is determined based on one of: (i) a difference between the respective second input sample and a top neighbor of the respective second input sample; (ii) a difference between the top neighbor of the respective second input sample and a bottom neighbor of the respective second input sample; and (iii) a difference between a first value and a second value, the first value being a sum based on a top-left neighbor, the top neighbor, and a top-right neighbor of the second input sample, the second value being a sum based on bottom-left neighbor, the bottom neighbor, and a bottom-right neighbor of the respective second input sample.

In an example, which of the differences is used to calculate the vertical gradient of the respective second input sample is determined based on a position of the respective second input sample.

At (S1440), a predicted value of the current sample is determined based on a sum of the linear predicted value and at least one modification value that includes the gradient value, an FIBC filter in the FIBC mode including the linear filter and the at least one gradient filter.

In an example, the predicted value of the current sample is clipped.

At (S1450), the current sample is reconstructed from the predicted value of the current sample.

Then, the process proceeds to (S1499) and terminates.

The process (1400) can be suitably adapted. Step(s) in the process (1400) can be modified and/or omitted. Additional step(s) can be added. Any suitable order of implementation can be used.

In an example, a location value is determined using a location of a center sample that is at a center of the linear filter, and the predicted value of the current sample is determined based on a sum of the linear predicted value and the at least one modification value that includes the gradient value and the location value. The FIBC filter in the FIBC mode includes the linear filter, the at least one gradient filter, and a location filter (e.g., coefficients for the location).

In an example, a nonlinear value associated with the current sample is determined from at least one of the current sample and neighboring samples of the current sample using a nonlinear relationship between the nonlinear value and values of the at least one of the current sample and the neighboring samples, and the predicted value of the current sample is determined based on a sum of the linear predicted value and the at least one modification value that includes the gradient value and the nonlinear value. The FIBC filter in the FIBC mode includes the linear filter, the at least one gradient filter, and a coefficient for the nonlinear value.

In an example, coefficients of the FIBC filter in the FIBC mode are determined from a current template of the current block and a reference template of a reference block indicated by a block vector of the current block.

In an example, the coefficients of the FIBC filter in the FIBC mode are determined using LDL decomposition.

In an example, a shape of the linear filter is predefined, and one or more shapes of the at least one gradient filter are predefined.

In an example, a sample in the linear filter is spatially separated from all remaining samples in the linear filter.

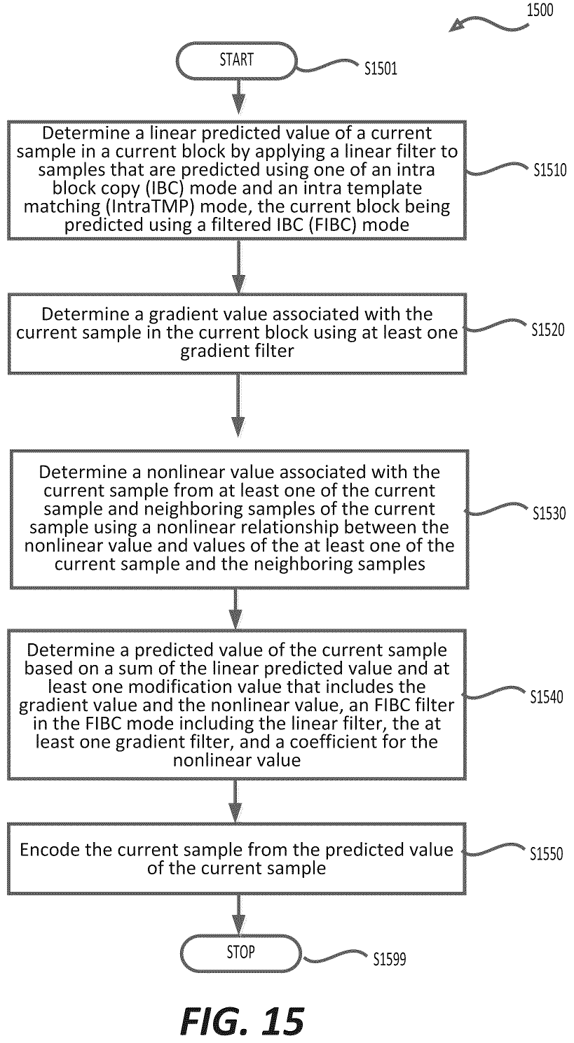

FIG. 15 shows a flow chart outlining a process (1500) according to an aspect of the disclosure. The process (1500) can be used in a video encoder. In various aspects, the process (1500) is executed by processing circuitry, such as the processing circuitry that performs functions of the video encoder (103), the processing circuitry that performs functions of the video encoder (303), and the like. In some aspects, the process (1500) is implemented in software instructions, thus when the processing circuitry executes the software instructions, the processing circuitry performs the process (1500). The process starts at (S1501) and proceeds to (S1510).

At (S1510), a linear predicted value of a current sample in a current block is determined by applying a linear filter to samples that are predicted using one of an intra block copy (IBC) mode and an intra template matching. The current block is predicted using a filtered IBC (FIBC) mode using an FIBC filter. The FIBC filter includes the linear filter.

In an example, the linear filter includes a bias term or the linear filter is configured to add a mean value of the current block and remove the mean value of the current block from each of the samples that are predicted using the one of the IBC mode and the IntraTMP mode.

At (S1520), a gradient value associated with the current sample in the current block is determined using at least one gradient filter. The FIBC filter includes the at least one gradient filter.

At (S1530), a nonlinear value associated with the current sample is determined from at least one of the current sample and neighboring samples of the current sample using a nonlinear relationship between the nonlinear value and values of the at least one of the current sample and the neighboring samples.

At (S1540), a predicted value of the current sample is determined based on a sum of the linear predicted value and at least one modification value that includes the gradient value and the nonlinear value. The FIBC filter in the FIBC mode includes the linear filter, the at least one gradient filter, and a coefficient for the nonlinear value.

At (S1550), the current sample is encoded from the predicted value of the current sample.

Then, the process proceeds to (S1599) and terminates.

The process (1500) can be suitably adapted. Step(s) in the process (1500) can be modified and/or omitted. Additional step(s) can be added. Any suitable order of implementation can be used.

In an example, a location value is determined using a location of a center sample that is at a center of the linear filter, and the predicted value of the current sample is determined based on the sum of the linear predicted value and the at least one modification value that includes the gradient value, the nonlinear value, and the location value. The FIBC filter in the FIBC mode includes the linear filter, the at least one gradient filter, the coefficient for the nonlinear value, and a location filter (e.g., coefficients for the location).

In an aspect, a method of processing visual media data is disclosed. The method includes processing a bitstream of the visual media data according to a format rule. The bitstream includes a syntax element indicating that a current block in a current picture is predicted using a filtered intra block copy (FIBC) mode. The format rule specifies that: a linear predicted value of a current sample in the current block is determined by applying a linear filter to samples that are predicted using one of an intra block copy (IBC) mode and an intra template matching (IntraTMP) mode; a gradient value associated with the current sample in the current block is determined using at least one gradient filter; a nonlinear value associated with the current sample is determined from at least one of the current sample and neighboring samples of the current sample using a nonlinear relationship between the nonlinear value and values of the at least one of the current sample and the neighboring samples; a location value is based on a location of a center sample that is at a center of the linear filter; a predicted value of the current sample is based on a sum of the linear predicted value and at least one modification value that includes the gradient value, the nonlinear value, and the location value, an FIBC filter in the FIBC mode including the linear filter, the at least one gradient filter, a coefficient for the nonlinear value, and coefficients for the location; and the current sample is processed from the predicted value of the current sample.

In an example, the linear filter includes a bias term.

In an example, the linear filter is configured to add a mean value of the current block and removes the mean value of the current block from each of the samples that are predicted using the one of the IBC mode and the IntraTMP mode.

Aspects and/or examples in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

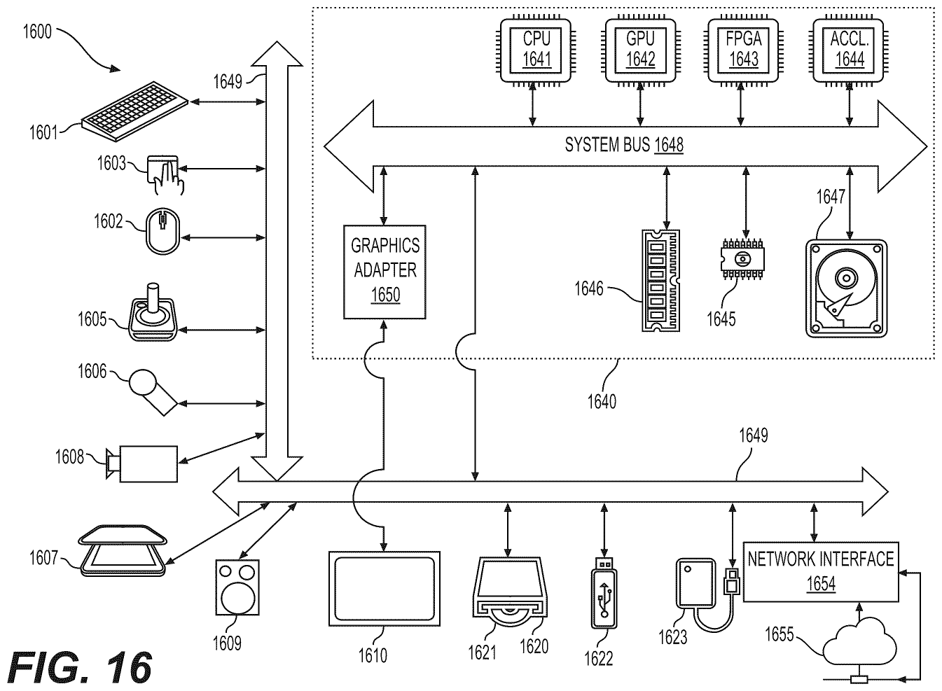

The techniques described above, can be implemented as computer software using computer-readable instructions and physically stored in one or more computer-readable media. For example, FIG. 16 shows a computer system (1600) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 16 for computer system (1600) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (1600).

Computer system (1600) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1601), mouse (1602), trackpad (1603), touch screen (1610), data-glove (not shown), joystick (1605), microphone (1606), scanner (1607), camera (1608).

Computer system (1600) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1610), data-glove (not shown), or joystick (1605), but there can also be tactile feedback devices that do not serve as input devices), audio output devices (such as: speakers (1609), headphones (not depicted)), visual output devices (such as screens (1610) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1600) can also include human accessible storage devices and their associated media such as optical media including CD/DVD ROM/RW (1620) with CD/DVD or the like media (1621), thumb-drive (1622), removable hard drive or solid state drive (1623), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1600) can also include an interface (1654) to one or more communication networks (1655). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1649) (such as, for example USB ports of the computer system (1600)); others are commonly integrated into the core of the computer system (1600) by attachment to a system bus as described below (for example Ethernet interface into a PC computer system or cellular network interface into a smartphone computer system). Using any of these networks, computer system (1600) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1640) of the computer system (1600).

The core (1640) can include one or more Central Processing Units (CPU) (1641), Graphics Processing Units (GPU) (1642), specialized programmable processing units in the form of Field Programmable Gate Areas (FPGA) (1643), hardware accelerators for certain tasks (1644), graphics adapters (1650), and so forth. These devices, along with Read-only memory (ROM) (1645), Random-access memory (1646), internal mass storage such as internal non-user accessible hard drives, SSDs, and the like (1647), may be connected through a system bus (1648). In some computer systems, the system bus (1648) can be accessible in the form of one or more physical plugs to enable extensions by additional CPUs, GPU, and the like. The peripheral devices can be attached either directly to the core's system bus (1648), or through a peripheral bus (1649). In an example, the screen (1610) can be connected to the graphics adapter (1650). Architectures for a peripheral bus include PCI, USB, and the like.

CPUs (1641), GPUs (1642), FPGAs (1643), and accelerators (1644) can execute certain instructions that, in combination, can make up the aforementioned computer code. That computer code can be stored in ROM (1645) or RAM (1646). Transitional data can also be stored in RAM (1646), whereas permanent data can be stored for example, in the internal mass storage (1647). Fast storage and retrieve to any of the memory devices can be enabled through the use of cache memory, that can be closely associated with one or more CPU (1641), GPU (1642), mass storage (1647), ROM (1645), RAM (1646), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1600), and specifically the core (1640) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1640) that are of non-transitory nature, such as core-internal mass storage (1647) or ROM (1645). The software implementing various aspects of the present disclosure can be stored in such devices and executed by core (1640). A computer-readable medium can include one or more memory devices or chips, according to particular needs. The software can cause the core (1640) and specifically the processors therein (including CPU, GPU, FPGA, and the like) to execute particular processes or particular parts of particular processes described herein, including defining data structures stored in RAM (1646) and modifying such data structures according to the processes defined by the software. In addition or as an alternative, the computer system can provide functionality as a result of logic hardwired or otherwise embodied in a circuit (for example: accelerator (1644)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. An apparatus for video decoding, comprising:
processing circuitry configured to:
receive coded information indicating that a current block in a current picture is predicted using a filtered intra block copy (FIBC) mode;
determine a linear predicted value of a current sample in the current block by applying a linear filter to prediction samples that are predicted using one of an IBC mode and an intra template matching (IntraTMP) mode;
determine a gradient value associated with the current sample in the current block using at least one gradient filter;
determine a predicted value of the current sample based on a sum of the linear predicted value and at least one modification value that includes the gradient value, an FIBC filter in the FIBC mode including the linear filter, and the at least one gradient filter; and
reconstruct the current sample from the predicted value of the current sample.

2. The apparatus of claim 1, wherein the processing circuitry is configured to:
determine a location value using a location of a center sample that is at a center of the linear filter; and
determine the predicted value of the current sample based on a sum of the linear predicted value and the at least one modification value that includes the gradient value and the location value, the FIBC filter in the FIBC mode including the linear filter, the at least one gradient filter, and coefficients for the location.

3. The apparatus of claim 1, wherein the processing circuitry is configured to:
determine a nonlinear value associated with the current sample from at least one of the current sample and neighboring samples of the current sample using a nonlinear relationship between the nonlinear value and values of the at least one of the current sample and the neighboring samples; and
determine the predicted value of the current sample based on a sum of the linear predicted value and the at least one modification value that includes the gradient value and the nonlinear value, the FIBC filter in the FIBC mode including the linear filter, the at least one gradient filter, and a coefficient for the nonlinear value.

4. The apparatus of claim 1, wherein the linear filter includes a bias term.

5. The apparatus of claim 1, wherein the linear filter adds a mean value of the current block and removes the mean value of the current block from each of the samples that are predicted using the one of the IBC mode and the IntraTMP mode.

6. The apparatus of claim 1, wherein the processing circuitry is configured to clip the predicted value of the current sample.

7. The apparatus of claim 1, wherein the processing circuitry is configured to determine coefficients of the FIBC filter in the FIBC mode from a current template of the current block and a reference template of a reference block indicated by a block vector of the current block.

8. The apparatus of claim 7, wherein the processing circuitry is configured to determine the coefficients of the FIBC filter in the FIBC mode using LDL decomposition.

9. The apparatus of claim 1, wherein the linear filter has a cross-shape that includes:
(i) 5 samples that include a center sample of the linear filter with an offset of (0, 0), a North sample N with an offset of (0, −1), a South sample S with an offset of (0, 1), an East sample E with an offset of (1, 0), and a West sample W with an offset of (−1, 0), the offsets of the 5 samples in the linear filter are with respect to the center sample; or
(ii) 9 samples that include a center sample of the linear filter with an offset of (0, 0), two North samples with respective offsets of (0, −1) and (0, −2), two South samples with respective offsets of (0, 1) and (0, 2), two East samples with respective offsets of (1, 0) and (2, 0), and two West samples with respective offsets of (−1, 0) and (−2, 0), the offsets of the 9 samples in the linear filter are with respect to the center sample.

10. The apparatus of claim 9, wherein
when the linear filter has the 5 samples, the current sample is located at one of 5 positions of the respective 5 samples; and
when the linear filter has the 9 samples, the current sample is located at one of 9 positions of the respective 9 samples.

11. The apparatus of claim 1, wherein a shape of the linear filter is predefined, and one or more shapes of the at least one gradient filter are predefined.

12. The apparatus of claim 1, wherein a sample in the linear filter is spatially separated from all remaining samples in the linear filter.

13. The apparatus of claim 1, wherein
when the at least one gradient filter consists of a horizontal gradient filter, the gradient value is a horizontal gradient value, and a number of first input samples and positions of the first input samples in the horizontal gradient filter are set independently from the linear filter;
when the at least one gradient filter consists of a vertical gradient filter, the gradient value is a vertical gradient value, and a number of second input samples and positions of the second input samples in the vertical gradient filter are set independently from the linear filter; and
when the at least one gradient filter includes a horizontal gradient filter and a vertical gradient filter, the gradient value is a sum of a horizontal gradient value and a vertical gradient value, and the number of the first input samples and the positions of the first input samples in the horizontal gradient filter and the number of the second input samples and the positions of the second input samples in the vertical gradient filter are set independently from each other and from the linear filter.

14. The apparatus of claim 1, wherein
the at least one gradient filter includes a horizontal gradient filter;
the gradient value includes a horizontal gradient value that is a sum of horizontal gradients of respective first input samples in the horizontal gradient filter; and
the processing circuitry is configured to determine each horizontal gradient of the respective first input samples based on one of:
(i) a difference between the respective first input sample and a left neighbor of the respective first input sample;
(ii) a difference between the left neighbor of the first input sample and a right neighbor of the respective first input sample; and
(iii) a difference between a first value and a second value, the first value being a sum based on a top-left neighbor, the left neighbor, and a bottom-left neighbor of the first input sample, the second value being a sum based on a top-right neighbor, the right neighbor, and a bottom-right neighbor of the first input sample.

15. The apparatus of claim 1, wherein
the at least one gradient filter includes a vertical gradient filter;
the gradient value includes a vertical gradient value that is a sum of vertical gradients of respective second input sample in the vertical gradient filter; and
the processing circuitry is configured to determine each vertical gradient of the respective second input sample based on one of:
(i) a difference between the respective second input sample and a top neighbor of the respective second input sample;
(ii) a difference between the top neighbor of the respective second input sample and a bottom neighbor of the respective second input sample; and
(iii) a difference between a first value and a second value, the first value being a sum based on a top-left neighbor, the top neighbor, and a top-right neighbor of the second input sample, the second value being a sum based on bottom-left neighbor, the bottom neighbor, and a bottom-right neighbor of the respective second input sample.

16. A method for video encoding, comprising:
determining a linear predicted value of a current sample in a current block by applying a linear filter to samples that are predicted using one of an intra block copy (IBC) mode and an intra template matching (IntraTMP) mode, the current block being predicted using a filtered IBC (FIBC) mode;
determining a gradient value associated with the current sample in the current block using at least one gradient filter;
determining a predicted value of the current sample based on a sum of the linear predicted value and at least one modification value that includes the gradient value, an FIBC filter in the FIBC mode including the linear filter, and the at least one gradient filter; and
encoding the current sample from the predicted value of the current sample.

17. The method of claim 16, further comprising:
determining a location value using a location of a center sample that is at a center of the linear filter; and
determining the predicted value of the current sample based on the sum of the linear predicted value and the at least one modification value that includes the gradient value and the location value, the FIBC filter in the FIBC mode including the linear filter, the at least one gradient filter, and coefficients for the location.

18. The method of claim 16, wherein
the linear filter includes a bias term; or
the linear filter is configured to add a mean value of the current block and remove the mean value of the current block from each of the samples that are predicted using the one of the IBC mode and the IntraTMP mode.

19. The method of claim 16, wherein the determining the predicted value comprises:
determining a nonlinear value associated with the current sample from at least one of the current sample and neighboring samples of the current sample using a nonlinear relationship between the nonlinear value and values of the at least one of the current sample and the neighboring samples; and
determining the predicted value of the current sample based on a sum of the linear predicted value and the at least one modification value that includes the gradient value and the nonlinear value, the FIBC filter in the FIBC mode including the linear filter, the at least one gradient filter, and a coefficient for the nonlinear value.

20. A non-transitory computer readable medium storing a video media bitstream encoded by an encoding method, the encoding method comprising:
determining a linear predicted value of a current sample in a current block by applying a linear filter to samples that are predicted using one of an intra block copy (IBC) mode and an intra template matching (IntraTMP) mode, the current block being predicted using a filtered IBC (FIBC) mode;
determining a gradient value associated with the current sample in the current block using at least one gradient filter;
determining a predicted value of the current sample based on a sum of the linear predicted value and at least one modification value that includes the gradient value, an FIBC filter in the FIBC mode including the linear filter, and the at least one gradient filter; and encoding the current sample from the predicted value of the current sample.
